(19) United States
(12) Patent Application Publication
(10) Pub. No.: US 2025/0242489 A1
(43) Pub. Date: Jul. 31, 2025

(54) PICKUP METHOD

(71) Applicant: SEIKO EPSON CORPORATION, Tokyo (JP)

(72) Inventors: Hiroyuki KANAI, SHIOJIRI-SHI (JP); Makihito HORI, SHIOJIRI-SHI (JP); Homare KURIBAYASHI, KITAAZUMI-GUN IKEDA-MACHI (JP)

(21) Appl. No.: 19/040,146

(22) Filed: Jan. 29, 2025

(30) Foreign Application Priority Data
Jan. 30, 2024 (JP) 2024-011742

(51) Int. Cl. B25J 9/16; B25J 13/08; B25J 15/00

(52) U.S. Cl. CPC B25J 9/1612; B25J 13/082; B25J 15/0033

(57) ABSTRACT

A pickup method for picking up an object having a recessed portion using a jig held by a robot includes inserting the jig into the recessed portion by the robot, detecting an end point for insertion of the jig into the recessed portion by using a force sensor of the robot, and picking up the object by the robot by moving the jig in a direction opposite to a direction of the insertion of the jig into the recessed portion.

### CROSS-REFERENCE TO RELATED APPLICATIONS

The present application is based on, and claims priority from JP Application Serial Number 2024-011742, filed Jan. 30, 2024, the disclosure of which is hereby incorporated by reference herein in its entirety.

### BACKGROUND OF THE INVENTION

### 1. Technical Field

The present disclosure relates to a pickup method.

### 2. Related Art

In general, laboratory automation is used for automating, using robots, tasks related to experiments and research that were conventionally performed by human workers. Examples of the tasks that may be desirable for automation through the laboratory automation include a dispensing operation of collecting a predetermined amount of liquid reagent by a pipette. In the dispensing operation, an operation of picking up a tip from a tip box is performed in order to attach the tip among tips arranged in the tip box beforehand to a tip end of the pipette. For example, a robot hand described in JP-A-2023-130116 is used to automate such a pickup operation.

However, a configuration of the robot hand disclosed in JP-A-2023-130116 is complicated, and there is a problem that cost for automating the pickup operation increases. Note that such a problem is not limited to the pickup of a tip to be attached to a pipette, and the same applies to pickup of various objects.

### SUMMARY OF THE INVENTION

(1) According to a first aspect of the present disclosure, a pickup method for picking up an object having a recessed portion using a jig held by a robot is provided. The pickup method includes inserting the jig into the recessed portion by the robot, detecting an end point for insertion of the jig into the recessed portion by using a force sensor of the robot, and picking up the object by the robot by moving the jig in a direction opposite to a direction of the insertion of the jig into the recessed portion.

### BRIEF DESCRIPTION OF DRAWINGS

FIG. 1 is an explanatory diagram schematically illustrating a configuration of a dispensing device according to an embodiment.

FIG. 2 is a block diagram schematically illustrating a configuration of the dispensing device according to the embodiment.

FIG. 3 is a flowchart of a procedure of dispensing control according to the embodiment.

FIG. 4 is a flowchart of a procedure of a tip attachment control according to the embodiment.

FIG. 5 is an explanatory diagram illustrating a pickup method according to another embodiment.

### DETAILED DESCRIPTION OF THE INVENTION

### A. Embodiment

### A-1: Device Configuration

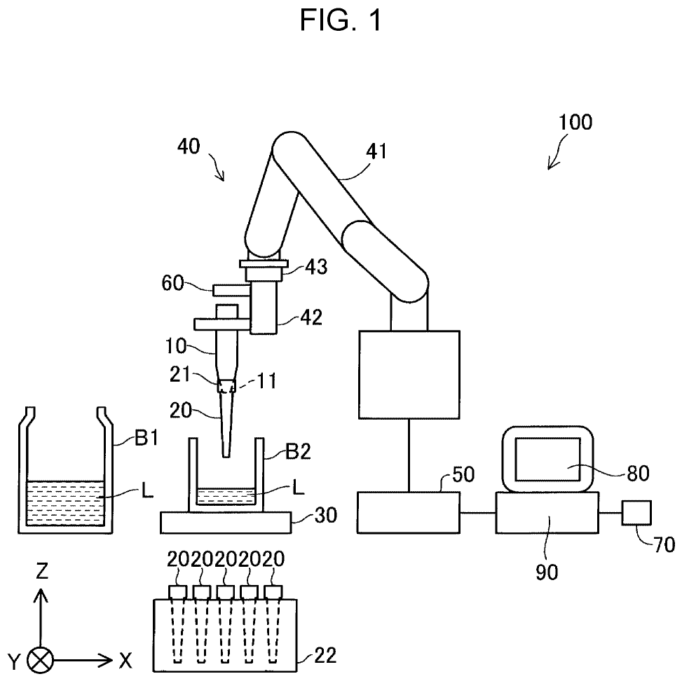

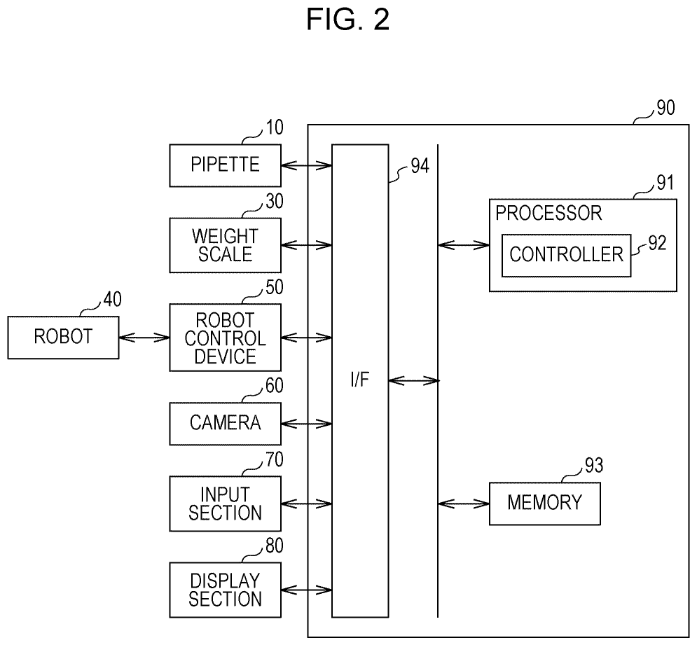

FIG. 1 is an explanatory diagram schematically illustrating a configuration of a dispensing device 100 according to an embodiment. FIG. 2 is a block diagram schematically illustrating a configuration of the dispensing device 100 according to this embodiment. In FIG. 1, X, Y and Z axes orthogonal to one another are illustrated. The X and Y axes correspond to a horizontal direction, and the Z axis corresponds to a vertical direction. Note that a term “X axis direction” refers to a concept of a combination of a +X direction and a −X direction. Similarly, a term “Y axis direction” refers to a concept of a combination of a +Y direction and a −Y direction, and a term “Z axis direction” refers to a concept of a combination of a +Z direction and a −Z direction. In the following description, the +Z direction is also referred to as “upward” and the −Z direction is also referred to as “downward”.

The dispensing device 100 is used to perform dispensing, or more specifically, to suck a liquid reagent L from a reagent bottle B1 containing the liquid reagent L of a type specified by a user and discharge a specified amount of liquid reagent L into a sample bottle B2. Note that, although only the reagent bottle B1 containing the liquid reagent L is illustrated in FIG. 1, the dispensing device 100 performs not only the dispensing of a single type of reagent but also dispensing of a plurality of types of liquid reagent in a plurality of reagent bottles to the sample bottle B2. As illustrated in FIG. 1, the dispensing device 100 includes a pipette 10, a tip 20, a weight scale 30, a robot 40, a robot control device 50, a camera 60, an input section 70, a display section 80, and a control device 90. Furthermore, as illustrated in FIG. 2, the pipette 10, the weight scale 30, the robot control device 50, the camera 60, the input section 70, the display section 80, and the control device 90 are electrically connected to one another. Note that, in FIG. 1, the electrical connection between the display section 80 and the pipette 10, the tip 20, the weight scale 30, and the camera 60 is omitted for the convenience of the illustration.

The pipette 10 is used with the tip 20 attached to an inserting portion 11 which is a tip end portion of the pipette 10, as illustrated in FIG. 1. In this embodiment, the inserting portion 11 is formed in a tapered shape in which an outer diameter increases from a distal end side in the −Z direction toward a base end side in +Z direction. Since the inserting portion 11 is formed in this way, the inserting portion 11 may be easily inserted into the tip 20.

The pipette 10 sucks the liquid reagent L stored in the reagent bottle B1 and discharges the sucked liquid reagent L into the sample bottle B2. A type of liquid reagent L is not particularly limited as long as the liquid reagent L can be sucked and discharged by the pipette 10. The pipette 10 is capable of sucking and discharging a predetermined volume of liquid reagent L when a drive section not illustrated is driven. The suction and the discharge of the liquid reagent L by the pipette 10 are controlled by the control device 90. The pipette 10 is, for example, a micropipette. As the pipette 10, any pipette 10 capable of sucking and discharging the liquid reagent L may be used. In this embodiment, the tip 20 is mainly formed of resin. Note that the tip 20 may be formed not only of resin but also of other materials, such as glass.

When the dispensing device 100 dispenses a plurality of types of liquid reagent L, the tip end of the pipette 10 is fitted with the tip 20 having a shape corresponding to a property, such as viscosity, of the liquid reagent L. The pipette 10 is grasped and moved by the robot 40, which will be described later, and is fitted with the tip 20 having a shape corresponding to a type of liquid to be dispensed among a plurality of tips 20 stored in the tip box 22 prepared in advance. A method for attaching the tip 20 to the pipette 10 will be described later.

The weight scale 30 measures a weight of the liquid reagent L discharged into the sample bottle B2 and outputs a result of the measurement to the control device 90. As illustrated in FIG. 1, the sample bottle B2 is mounted on the weight scale 30. The sample bottle B2 is, for example, a beaker. The weight scale 30 is, for example, an electronic balance. Note that a type of the weight scale 30 is not limited to an electronic balance, and is not particularly limited as long as a weight of the liquid reagent L may be measured.

The robot 40 grasps the pipette 10 and is controlled by the robot control device 50 to move the pipette 10 so as to realize the dispensing operation instructed by the control device 90. The robot 40 has an arm 41, a hand 42, and a force sensor 43. In this embodiment, the robot 40 is configured as a six-axis robot. The hand 42 is attached to a tip end portion of the arm 41 through the force sensor 43. The hand 42 is controlled by the robot control device 50 to grasp the pipette 10.

The force sensor 43 detects a force applied to the hand 42 and outputs a result of the detection to the robot control device 50. In this embodiment, the force sensor 43 detects magnitudes of forces parallel to three detection axes orthogonal to one another in a unique sensor coordinate system and a magnitude of torque around the three detection axes. Note that the force sensor 43 may be disposed at a position other than the tip end of the hand 42, for example, at one or more of a plurality of joints of the arm 41. The force sensor 43 corresponds to a “force sensor” in the present disclosure. Note that the force sensor is not limited to a sensor capable of detecting forces in a multiaxial direction, such as the force sensor 43, and may be a sensor capable of detecting a force in a single axis direction, for example.

In this embodiment, the robot control device 50 may perform impedance control using a result of the detection of the force sensor 43. The term “impedance control” means control of a position and a pressing force of the arm 41 and the hand 42 so that a sensor value of the force sensor 43 is equal to a preset value. For example, when control of contact of an object grasped by the hand 42 to another object with a predetermined pressing force is performed, the robot control device 50 performs position control to release the pressed object from the hand 42 when the sensor value of the force sensor 43 is equal to or greater than a predetermined threshold value. On the other hand, the robot control device 50 performs position control to bring the hand 42 closer to the object to be pressed when the sensor value falls below the threshold value described above. By such impedance control, the hand 42 can be pressed against the object to be pressed with a predetermined pressing force. In the following description, a function which is realized by impedance control and which brings the hand 42 closer to the object to be pressed and stops the robot 40 when a force exceeding a first predetermined threshold value is detected by the force sensor 43 is referred to as a “contact detection function”. Furthermore, a function which is realized by impedance control and which presses the hand 42 against the object to be pressed with a predetermined pressing force and stops the robot 40 when a force exceeding a predetermined second threshold value is detected by the force sensor 43 is referred to as a “pressing function”.

In this embodiment, the camera 60 is installed in a position, in the hand 42, that does not interfere with an object when the object is grasped by the hand 42. As will be described later, the control device 90 corrects a robot coordinate of the robot 40 by using an image captured by the camera 60.

The input section 70 is a device for the user to input various information to the control device 90. The input section 70 is configured as, for example, a mouse, a touch panel, or a keyboard.

The display section 80 displays an image captured by the camera 60 and an input image to be used by the user to input various information to the control device 90. The display section 80 is configured as, for example, an LCD (Liquid Crystal Display), an Organic EL (Electroluminescence) display, an EPD (Electrophoretic Display), a touch panel type display, or the like.

As illustrated in FIG. 2, the control device 90 has a processor 91, a memory 93, and an interface 94. The control device 90 is electrically connected to the pipette 10, the weight scale 30, the robot control device 50, the camera 60, the input section 70, and the display section 80 via the interface 94 in a wired or wireless manner. The memory 93 stores programs, data, and the like for the control device 90 to perform various calculation processes and control processes. Furthermore, the memory 93 stores information received from the camera 60 and the weight scale 30, information input by the user using the input section 70, results of calculations executed by the control device 90 in accordance with various programs, etc. The processor 91 functions as a controller 92 by executing programs stored in the memory 93 in advance. The controller 92 executes various controls to achieve dispensing control.

### A-2: Dispensing Control

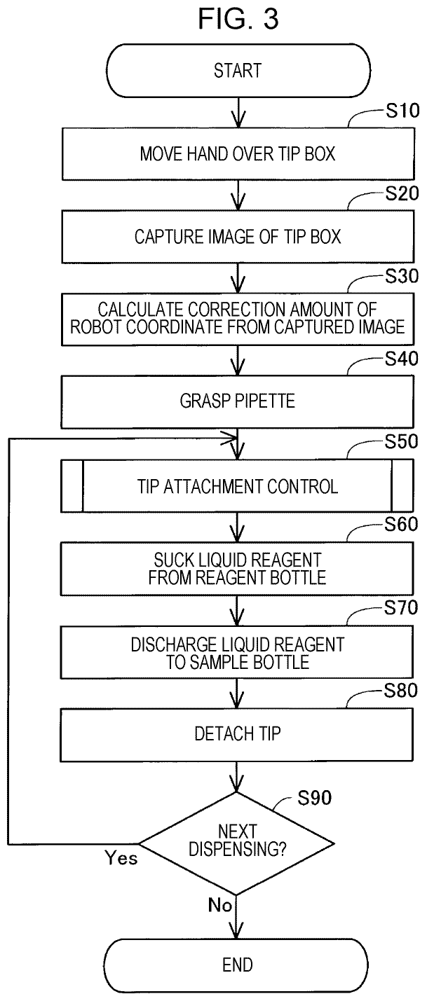

FIG. 3 is a flowchart of a procedure of the dispensing control according to this embodiment. This control is executed, for example, by the controller 92 when a predetermined start operation is performed by the user using the input section 70 on the control device 90. The hand 42 does not grasp the pipette 10 at a start of this control. Note that, in the following description, in order to facilitate understanding of the technology, control executed by the control device 90 through the robot control device 50 is also anchored by the “control device 90”.

In step S10, the controller 92 controls the robot 40 to move the hand 42 over the tip box 22. Movement destination coordinates of the hand 42 are predetermined as coordinates for performing coordinate correction described later. Also, at this time, the tip box 22 is pre-installed in a tip box holder, not illustrated, disposed in a predetermined position. In this embodiment, the tip box holder is formed in a groove shape, and positioning of the tip box 22 is performed by installing the tip box 22 in the tip box holder. Note that, in FIG. 1, tips 20 are illustrated in a row along the X direction in the tip box 22, but in reality, the tips are planarly arranged in an X-Y plane at regular intervals from one another. Furthermore, the tips 20 may be arranged in the X-Y plane or may be arranged so as to be inclined with respect to the X-Y plane, in the tip box 22.

In step S20, the controller 92 controls the camera 60 to capture an image of the tip box 22.

In step S30, the controller 92 utilizes the captured image of the tip box 22 to calculate a difference between robot coordinates of one of the tips 20 logically calculated using a position of the tip 20 located in an arbitrary position in the tip box 22 and a position of the tip box holder, for example, and image coordinates so as to calculate correction amounts of the robot coordinates. More specifically, the controller 92 uses an image of the tip box 22 to detect an outer shape of the insertion accepting portion 21 of the tip 20 into which the inserting portion 11 is inserted by image analysis, and to identify center coordinates of the insertion accepting portion 21 in the image. The controller 92 calculates a difference between the center coordinates of the identified insertion accepting portion 21 and center coordinates logically calculated as described above. In the following explanation, such a difference is also referred to as a “correction amount”. The controller 92 may correct the difference in the robot coordinates of the insertion accepting portion 21 that may be caused by arrangement of the tip box 22 based on the calculated correction amount. The insertion accepting portion 21 corresponds to a “recessed portion” in the present disclosure. Note that a method for calculating the correction amount using the image is performed with the arbitrary one tip in the foregoing description, but may be performed with a plurality of tips. In addition, a method for identifying the center coordinates of the insertion accepting portion 21 is not limited to that in the above-described embodiment, and any known method may be used.

In step S40, the controller 92 controls the robot 40 to grasp the pipette 10. More specifically, the controller 92 controls the robot 40 to move the hand 42 to a pipette rack, not illustrated, in which the pipette 10 is installed in advance and causes the hand to grasp the pipette 10.

In step S50, the controller 92 executes tip attaching control so as to attach the tip 20 to the inserting portion 11. A procedure of tip attaching control in this embodiment will be described later.

In step S60, the controller 92 controls the pipette 10 to suck the liquid reagent L from the reagent bottle B1. In step S70, the controller 92 controls the pipette 10 to discharge the liquid reagent L into the sample bottle B2. A type of liquid reagent L to be sucked in step S50 and an amount of liquid reagent L to be discharged in step S60 are inputted in advance by the user and stored in the memory 93. Note that the operation of the robot 40, such as insertion and retraction of the pipette 10 with respect to the reagent bottle B1 and the sample bottle B2, performed in steps S60 and S70, respectively, is the same as an operation performed in general dispensing control, and therefore, the detailed description thereof is omitted.

In step S80, the controller 92 removes the tip 20 attached to the inserting portion 11. Since the control for removing the tip 20 is similar to an operation performed in the general dispensing control, a detailed description thereof is omitted.

In step S90, the controller 92 determines whether next dispensing is to be performed. When it is determined that next dispensing is to be performed (step S90: Yes), the controller 92 executes the above-described step S50 again and attaches a new one of the tips 20 to the inserting portion 11. When it is determined that next dispensing is not to be performed (step S90: No), the controller 92 terminates the dispensing control.

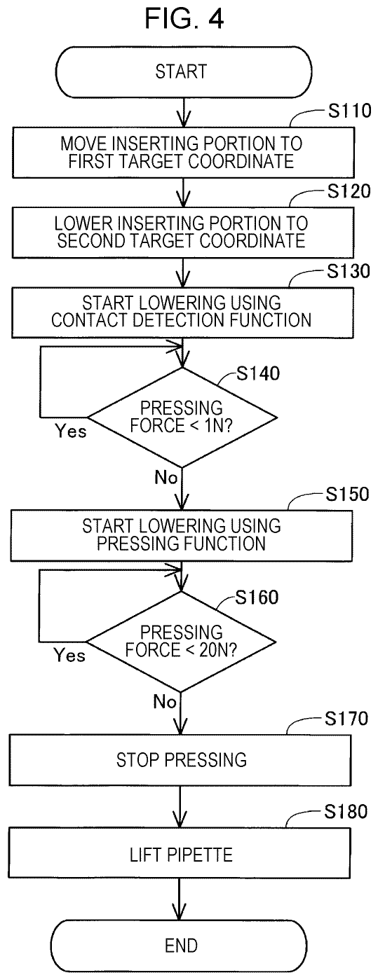

The tip attaching control described above will now be described. FIG. 4 is a flowchart of a procedure of the tip attaching control according to this embodiment. The control device 90 attaches one of the tips 20 to the inserting portion 11 by executing the tip attaching control, so as to pick up the tip 20 from the tip box 22. The pipette 10 corresponds to a “jig” in the present disclosure, and the tip 20 corresponds to an “object” in the present disclosure. In addition, a method for picking up one of the tips 20 realized by the tip attaching control corresponds to a “pickup method” in the present disclosure.

In step S110, the controller 92 controls the robot 40 to move the inserting portion 11 to first target coordinates. In this embodiment, the first target coordinates are located directly above the center coordinates obtained by applying a correction amount to coordinates of the insertion accepting portion 21 of the tip 20 to be attached which are logically calculated in accordance with a position of the tip box holder, and are located several tens of centimeters above a +Z side end portion of the tip 20 in the +Z direction.

In step S120, the controller 92 controls the robot 40 to move the inserting portion 11 to second target coordinates. In this embodiment, the second target coordinates are located directly above the center coordinates obtained by applying a correction amount to coordinates of the insertion accepting portion 21 of the tip 20 to be attached which are logically calculated in accordance with a position of the tip box holder, and are located approximately 1 centimeter above the +Z side end portion of the tip 20 in the +Z direction.

In step S130, the controller 92 controls the robot 40 to start lowering the inserting portion 11 by using the contact detection function described above. Since a movement speed of the robot 40 is limited during the use of the contact detection function, a period of time required for the tip attaching control may be reduced when the contact detection function is used after the movement to the second target coordinates, when compared with a form in which the use of the contact detection function is started at the first target coordinates.

In step S140, the control device 90 determines whether a pressing force detected by the force sensor 43 is less than 1N. The control device 90 determines that the inserting portion 11 is in contact with the insertion accepting portion 21 when the pressing force becomes 1N or more. By bringing the inserting portion 11 to contact with the insertion accepting portion 21, the distal end of the inserting portion 11 is inserted into the insertion accepting portion 21. Here, “1N” corresponds to the “first threshold value” in the above-mentioned contact detection function. Note that the first threshold value may be arbitrarily set to an appropriate value according to a shape and material of the tip 20. In this embodiment, since the contact of the inserting portion 11 with the insertion accepting portion 21 is detected by using the force sensor 43, the inserting portion 11 may be contact with the insertion accepting portion 21 without requiring detailed instruction to the robot 40, even when an article whose shape varies according to a type as in the tip 20 of this embodiment and whose size is likely to be varied because of a main material of resin is a pickup target. Step S130 and step S140 correspond to “inserting” in the present disclosure.

When it is determined that a pressing force is less than 1N (step S140: Yes), the control device 90 continues to lower the inserting portion 11 or, in other words, continues approach of the inserting portion 11 to the insertion accepting portion 21, as the inserting portion 11 has not yet been in contact with the insertion accepting portion 21. When it is determined that the pressing force is 1N or more (step S140: No), the control device 90 starts lowering the inserting portion 11 by using the pressing function described above in step S150.

In step S160, the control device 90 determines whether the pressing force detected by the force sensor 43 is less than 20N. The control device 90 detects that the inserting portion 11 has reached an end point of insertion into the insertion accepting portion 21 when the pressing force becomes 20N or more. “20N” corresponds to the “second threshold value” in the contact detection function described above. Note that an appropriate value may be arbitrarily set as the second threshold value according to a shape, material, and the like of the tip 20. In this embodiment, since the force sensor 43 is utilized to detect that the inserting portion 11 has reached the end point of insertion into the insertion accepting portion 21, the inserting portion 11 may be inserted to the end point with respect to the insertion accepting portion 21 without requiring detailed instruction to the robot 40, even when a pickup target is an article having a unique shape according to a type, as in the tip 20 of this embodiment, and a unique distance to the end point after the insertion is started. Step S150 and step S160 correspond to “detecting an end point” in the present disclosure.

When it is determined that the pressing force is less than 20N (step S160: Yes), the control device 90 continues to lower the inserting portion 11, or in other words, to press the inserting portion 11 into the insertion accepting portion 21 since the pressing of the inserting portion 11 into the insertion accepting portion 21 is insufficient. When it is determined that the pressing force is 20N or more (step S160: No), the control device 90 stops pressing the inserting portion 11 into the tip 20 since the inserting portion 11 has been sufficiently inserted into the insertion accepting portion 21 in step S170.

In step S180, the control device 90 raises the pipette 10 in the +Z direction, that is, moves the pipette 10 in a direction opposite to an insertion direction of the inserting portion 11 with respect to the insertion accepting portion 21. Since the tip 20 is held in the pipette 10 by a frictional force that occurs between the inserting portion 11 and the insertion accepting portion 21 in a state in which the inserting portion 11 is sufficiently inserted into the insertion accepting portion 21, the tip 20 is picked up from the tip box 22 by raising the pipette 10. Step S180 corresponds to “picking up” in the present disclosure. Thus, the controller 92 terminates the tip attaching control.

According to the tip attaching control executed in the dispensing device 100 of the embodiment described above, the end point of insertion of the inserting portion 11 into the insertion accepting portion 21 is detected using the force sensor 43, and the tip 20 is picked up by moving the pipette 10 in the +Z direction by the robot 40 in the state in which the inserting portion 11 is inserted into the insertion accepting portion 21 to the end point. Therefore, the operation of picking up the tip 20 from the tip box 22 may be realized by a simple configuration, and an increase in cost for automating the pickup operation may be suppressed. In addition, in this embodiment, since the force sensor 43 is utilized to detect that the inserting portion 11 has reached the end point of insertion into the insertion accepting portion 21, the inserting portion 11 may be inserted into the insertion accepting portion 21 to the end point without requiring detailed instruction to the robot 40, even when a pickup target is an article having a unique shape according to a type, as in the tip 20 of this embodiment, and a unique distance to the end point after the insertion is started.

Furthermore, since the inserting portion 11 is formed in a tapered shape with an outer diameter increasing from a distal end thereof to a base end thereof, it is easy to guide the inserting portion 11 into the insertion accepting portion 21 and to facilitate the insertion into the insertion accepting portion 21.

Moreover, even when the tip 20 formed mainly of resin and prone to variation in a size is a pickup target, the pickup operation may be realized with a simple configuration, and increase in cost for automating the pickup operation may be suppressed.

In addition, the pickup operation may be realized with a simple configuration by using the pipette 10 as a jig, and increase in cost for automating the pickup operation may be suppressed.

### B. Other Embodiments

(B1) In the above embodiment, the inserting portion 11 is formed in a tapered form, but the present disclosure is not limited thereto. The inserting portion 11 may be formed in a cylindrical shape with a constant outer diameter from the tip end thereof to the base end thereof. Also in this embodiment, the tip 20 may be picked up by moving the pipette 10 in the +Z direction by the robot 40 in the state in which the inserting portion 11 is inserted into the insertion accepting portion 21 to the end point.

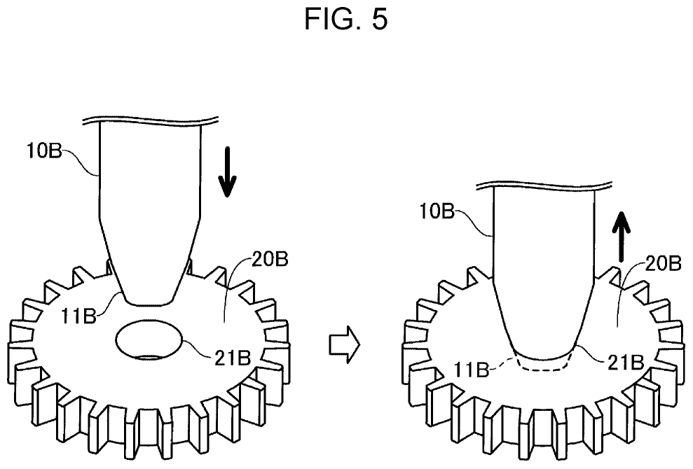

(B2) In the above embodiment, the pickup method is realized as a method of picking up the tip 20 by the pipette 10, but the present disclosure is not limited thereto. FIG. 5 is an explanatory diagram illustrating a pickup method according to another embodiment. The pickup method of the present disclosure may be realized as a method for picking up a gear member 20B using a jig 10B as illustrated in FIG. 5. Note that, in FIG. 5, illustration of a robot or the like grasping the jig 10B is omitted. Also in this modification, as illustrated in FIG. 5, the gear member 20B may be picked up by moving the jig 10B in a direction opposite to an insertion direction after an inserting portion 11B, which is a tip end portion of the jig 10B, is inserted into an end point in a hole 21B of the gear member 20B, and therefore, the gear member 20B may be picked up in an easy manner. Note that the hole 21B may not be penetrated. The hole 21B corresponds to the “recessed portion” in the present disclosure. Thus, the pickup method of the present disclosure is applicable not only to the pickup of the tip 20 using the pipette 10, but also to pickup of any object having a recessed portion.

Furthermore, the pickup method may be realized with a jig and an object formed to have a snap-fit structure that is engaged with each other by elastic deformation. Also with such a mode, the object is picked up by moving the jig in a direction opposite to the insertion direction after the object is inserted into the jig to the end point so as to be engaged with the jig, and therefore, the object may be picked up in an easy manner.

### C. Other Modes

The present disclosure is not limited to the above-described embodiments, and may be realized in various configurations without departing from the scope of the present disclosure. For example, the technical features of the embodiments corresponding to technical features of individual modes described hereinafter may be replaced or combined accordingly to solve some or all of the above-mentioned problems or to achieve some or all of the above-mentioned effects. Furthermore, when the technical features are not described as essential in this specification, they may be deleted accordingly.

(1) According to a first aspect of the present disclosure, a pickup method for picking up an object having a recessed portion using a jig held by a robot is provided. The pickup method includes inserting the jig into the recessed portion by the robot, detecting an end point for insertion of the jig into the recessed portion by using a force sensor of the robot, and picking up the object by the robot by moving the jig in a direction opposite to a direction of the insertion of the jig into the recessed portion. According to this aspect, the end point of insertion of the jig into the recessed portion is detected by the force sensor, and the object is picked up by moving the jig in the direction opposite to the insertion direction by the robot. Therefore, the object pickup operation may be realized by a simple configuration, and the increase in cost for automating the pickup operation may be suppressed.

(2) According to the aspect, the inserting portion, which is a portion to be inserted into the recessed portion in the jig, may be formed in a tapered shape with an outer diameter increasing from a distal end side to a base end side of the jig. According to this aspect, the inserting portion is formed in a tapered shape with an outer diameter increasing from the distal end side toward the base end side, so that insertion into the recessed portion may be easily made.

(3) According to the above aspect, the object may be mainly made of resin. According to this aspect, even when an object formed mainly of resin and having a large variation in size is a pickup target, the pickup operation may be realized with a simple configuration, and increase in cost for automating the pickup operation may be suppressed.

(4) According to the above aspect, the jig may be a pipette. According to this aspect, the pickup operation may be realized with a simple configuration by using the pipette 10 as a jig, and increase in cost for automating the pickup operation may be suppressed.

1. A pickup method for picking up an object having a recessed portion using a jig held by a robot, the method comprising:
inserting the jig into the recessed portion by the robot;
detecting an end point for insertion of the jig into the recessed portion by using a force sensor of the robot; and
picking up the object by the robot by moving the jig in a direction opposite to a direction of the insertion of the jig into the recessed portion.

2. The pickup method according to claim 1, wherein an inserting portion, which is a portion of the jig to be inserted into the recessed portion, is formed in a tapered shape with an outer diameter increasing from a distal end side of the jig toward a base end side.

3. The pickup method according to claim 1, wherein the object is mainly formed of resin.

4. The pickup method according to claim 1, wherein the jig is a pipette.
